(19) United States
(12) Patent Application Publication
(10) Pub. No.: US 2016/0133921 A1
(43) Pub. Date: May 12, 2016

(54) COMPOSITE HAVING METAL FLUORIDE AND POROUS CARBON, METHOD FOR PREPARING THE SAME, AND LITHIUM ION BATTERY COMPRISING THE SAME

(71) Applicant: POSTECH ACADEMY-INDUSTRY FOUNDATION, Pohang-si (KR)

(72) Inventors: Jinwoo LEE, Seoul (KR); Jinyoung CHUN, Gyeonggi-do (KR); Youngsik KIM, Ulsan (KR)

(73) Assignee: POSTECH ACADEMY-INDUSTRY FOUNDATION

(21) Appl. No.: 14/934,273

(22) Filed: Nov. 6, 2015

(30) Foreign Application Priority Data
Nov. 7, 2014 (KR) 10-2014-0154463

(51) Int. Cl. H01M 4/36; H01M 4/583; H01M 10/0525; H01M 4/58

(52) U.S. Cl. CPC H01M 4/362; H01M 4/582; H01M 4/583; H01M 10/0525; H01M 2220/30

(57) ABSTRACT

Disclosed is a composite, which includes a carrier, including porous carbon with a plurality of pores, and metal fluoride, loaded on the porous carbon, whereby the composite enables reversible charging and discharging in an electrochemical reaction, and can be used as a high-capacity electrode material. As this composite can be utilized as a cathode material for a lithium ion battery, energy density and cycling characteristics can be improved. Also, the preparation of the composite involves a solventless reaction, thus minimizing the loss of product due to the partial dissolution of a fluoride compound, realizing a very simple synthesis procedure, and obviating the need for a hazardous hydrofluoric acid aqueous solution or toxic gases, which require specific handling equipment, ultimately achieving a safe preparation process.

### TECHNICAL FIELD

The present invention relates to a composite comprising metal fluoride and porous carbon, a method of preparing the same, and a lithium ion battery including the same. More particularly, the present invention relates to a composite, which may be used to realize large capacity, depending on the discharge rate, and high operating voltage, and is thus useful as a cathode material having high energy density in a lithium ion battery, a method of preparing the same, and a lithium ion battery including the same as a cathode material.

### BACKGROUND ART

Conventional non-rechargeable batteries are referred to as primary batteries, and rechargeable batteries are called secondary batteries. Lithium ion batteries are constructed in a manner in which an organic electrolyte is interposed between a cathode and an anode so that charging and discharging are repeated. As the lithium ions of the anode are moved toward the cathode via the intermediate electrolyte, electricity may be generated. Since lithium ion batteries are lightweight and have high energy density, they may possess high capacity and may thus be utilized in a variety of electronic devices, such as mobile phones, notebook computers, digital cameras, etc.

With the drastic increase in the need for the development of high-capacity electrode materials for lithium ion batteries, thorough research is ongoing into novel electrode materials that are able to replace currently available lithium intercalation/deintercalation-based electrode materials. Materials that may be subjected to conversion or alloying with lithium may exchange several lithium atoms per unit molecule and are receiving attention as next-generation high-capacity electrode materials. However, most of the materials that are able to undergo the above reactions have low operating voltage for lithium exchange, and may be limitedly applied only to the anode.

Useful as an example of metal fluoride, copper fluoride (CuF₂) is easily hydrated in air and may easily undergo defluorination in the course of heat treatment, making it difficult to synthesize a nano structure. Furthermore, as copper ions are dissolved in the electrolyte in the electrochemical reaction, reversible charging and discharging cannot be carried out, and thus it is difficult to apply such a fluoride to the cathode for a rechargeable secondary battery.

### DISCLOSURE

### Technical Problem

Accordingly, the present invention has been made keeping in mind the above problems occurring in the related art, and the present invention is intended to provide a composite, which enables reversible charging and discharging in the electrochemical reaction and may be used as a high-capacity electrode material, and also to provide a superior energy storage device using the composite as a cathode material for a lithium ion battery, thus exhibiting improved energy density and cycling characteristics.

In addition, the present invention is intended to provide a method of preparing a composite, which may be carried out through a solventless reaction, thus minimizing the loss of product attributable to the partial dissolution of a fluoride compound, realizing a very simple synthesis procedure, and obviating the use of a hazardous hydrofluoric acid aqueous solution or toxic gases, which require specific handling equipment, thereby achieving very safe and efficient preparation of the composite.

### Technical Solution

An aspect of the present invention provides a composite, comprising: a carrier including porous carbon with a plurality of pores; and metal fluoride loaded on the porous carbon.

The metal fluoride may be loaded on the inner wall of the carbon in the pores.

The metal fluoride may comprise at least one selected from among copper fluoride (CuF₂), cobalt fluoride (CoF₂), iron fluoride (FeF₂, FeF₃), and nickel fluoride (NiF₂).

The pores may have a diameter of 1 to 100 nm.

The metal fluoride may be used in an amount of 30 to 90 wt % based on the total weight of the composite.

Another aspect of the present invention provides a method of preparing a composite, comprising: (a) providing a carrier including porous carbon with a plurality of pores; (b) loading a metal precursor on the porous carbon, thus forming a metal precursor-loaded carrier; (c) mixing the metal precursor-loaded carrier with ammonium fluoride (NH₄F), thus obtaining a mixture; and (d) heat-treating the mixture in any one atmosphere selected from among an inert gas, nitrogen gas, and a vacuum, yielding a composite comprising a carrier including porous carbon with a plurality of pores and metal fluoride loaded on the porous carbon.

The metal fluoride may be loaded on the inner wall of the carbon in the pores.

The carrier may be prepared using a hard template process.

The metal precursor may comprise at least one selected from among copper, cobalt, iron, and nickel.

The metal precursor may comprise at least one selected from among Cu(NO₃)₂.xH₂O, CuCl₂.xH₂O, Cu(OH)₂.xH₂O, Cu(CH₃COO)₂.xH₂O, CU₂(OH)₃NO₃, (NH₄)₂CuF₄, NH₄CuF₃, Cu(OH) F, CuO, and Cu₂O, where x is 0 to 6.

In the method, (b) may be performed using a wet impregnation process, comprising dissolving the metal precursor in a solvent to obtain a metal precursor solution and impregnating the carrier with the metal precursor solution.

The solvent may comprise at least one selected from among ethanol, methanol, acetone, water, tetrahydrofuran, and chloroform.

After the wet impregnation process, stirring and drying may be performed.

The method may further comprise performing drying at 50 to 100° C., after (b).

The ammonium fluoride in the mixture in (c) may be contained in an amount of two to ten times a molar number of a metal contained in the metal precursor.

The method may further comprise grinding the mixture, after (c).

The inert gas may be argon.

The heat-treating in (d) may be performed at 150 to 300° C.

A further aspect of the present invention provides a lithium ion battery, comprising the above composite as a cathode active material.

The lithium ion battery may comprise a solid electrolyte.

### Advantageous Effects

According to the present invention, a composite comprising metal fluoride and porous carbon enables reversible charging and discharging in the electrochemical reaction, and can be used as a high-capacity electrode material. As the composite of the invention can be utilized as a cathode material for a lithium ion battery, energy density and cycling characteristics can be improved.

Also, the preparation of the composite can be carried out through a solventless reaction, thus minimizing the loss of product due to the partial dissolution of a fluoride compound and realizing a very simple synthesis procedure. Furthermore, there is no need for a hazardous hydrofluoric acid aqueous solution or toxic gases, which require specific handling equipment, thereby achieving a safe preparation process.

### DESCRIPTION OF DRAWINGS

The above and other objects, features and advantages of the present invention will be more clearly understood from the following detailed description taken in conjunction with the accompanying drawings, in which:

FIG. 1 is a flowchart sequentially illustrating the process of preparing a composite according to the present invention;

FIG. 2 schematically illustrates the preparation of the composite in Example 1 according to the present invention;

FIG. 3 schematically illustrates the lithium ion battery manufactured in Device Example 1;

FIG. 4A illustrates the results of analysis of X-ray diffraction (XRD) in Test Example 1, FIG. 4B illustrates the results of analysis of XRD for changes in crystal phase of a copper precursor/MSU-F-C composite during heat treatment with ammonium fluoride (NH₄F), and FIG. 4C illustrates the results of thermogravimetric analysis (TGA);

FIG. 5 illustrates the results of analysis of XRD for the conversion of various copper precursors into CuF₂ through heat treatment in Test Example 2;

FIG. 6 illustrates SEM and TEM images of the CuF₂/MSU-F-C composite of Example 1, the bulky CuF₂ of Comparative Example 1, and the MSU-F-C of Comparative Example 3, in Test Example 3;

FIG. 7A illustrates the results of analysis of nitrogen physisorption isotherms for the products of Example 1 and Comparative Examples 3 and 4 (copper precursor/MSU-F-C composite) in Test Example 3, and FIG. 7B illustrates the results of analysis of the pore distribution thereof;

FIG. 8A illustrates the initial charge/discharge profile of the lithium ion battery in Test Example 4, and FIG. 8B illustrates the results of analysis of the XRD pattern of the CuF₂/MSU-F-C electrode in the electrochemical reaction;

FIG. 9A illustrates the TEM image after charging of the CuF₂/MSU-F-C electrode of Device Example 1 in Test Example 5, and FIG. 9B illustrates the results of elemental mapping thereof; and

FIG. 10A illustrates the voltage profile of CuF₂/MSU-F-C of the lithium ion battery in Test Example 6 at 15 cycles, and FIG. 10B illustrates the cycling characteristics of the electrode material in the lithium ion battery.

### NODE FOR INVENTION

Hereinafter, a detailed description will be given of embodiments of the present invention with reference to the appended drawings so that the present invention may be easily carried out by those skilled in the art to which the present invention belongs.

However, the following description is not intended to limit the present invention to specific embodiments, and a detailed description of the related known technology that may unnecessarily obscure the gist of the present invention will be omitted.

The terms used herein are merely employed to explain specific embodiments, and the present invention is not limited thereby. Unless otherwise stated, the singular expression includes a plural expression. In this application, the terms “include”, “have”, etc. are used to designate the presence of features, numbers, steps, operations, components, or combinations thereof described in the specification, and should be understood as not excluding the presence or additional probability of one or more different features, numbers, steps, operations, components, or combinations thereof.

Below is a description of the composite according to the present invention.

The composite according to the present invention comprises a carrier including porous carbon with a plurality of pores, and metal fluoride loaded on the porous carbon.

Preferably, metal fluoride may be loaded on the inner wall of the carbon in the pores.

Examples of the metal fluoride may include copper fluoride (CuF₂), cobalt fluoride (CoF₂), iron fluoride (FeF₂, FeF₃), and nickel fluoride (NiF₂), but the present invention is not limited thereto.

Metal fluoride shows a high theoretical operating voltage of 2.5 V or more and has a theoretical capacity of 500 mAh/g or more through a conversion reaction, and is thus expected to be a next-generation high-energy-density cathode material. In particular, copper fluoride (CuF₂) has a theoretical operating voltage of 3.55 V, which is regarded as the highest among examples of metal fluoride, and also has a high theoretical capacity exceeding 500 mAh/g, and thus the use thereof as a high-energy-density cathode material is expected.

The pores of the carrier have a diameter of 1 to 100 nm, preferably 3 to 70 nm, and more preferably 10 to 50 nm. Nanoparticles having a size of 10 nm or more may be effectively loaded within the pores.

The amount of metal fluoride is 30 to 90 wt %, and preferably 50 to 70 wt %, based on the total weight of the composite.

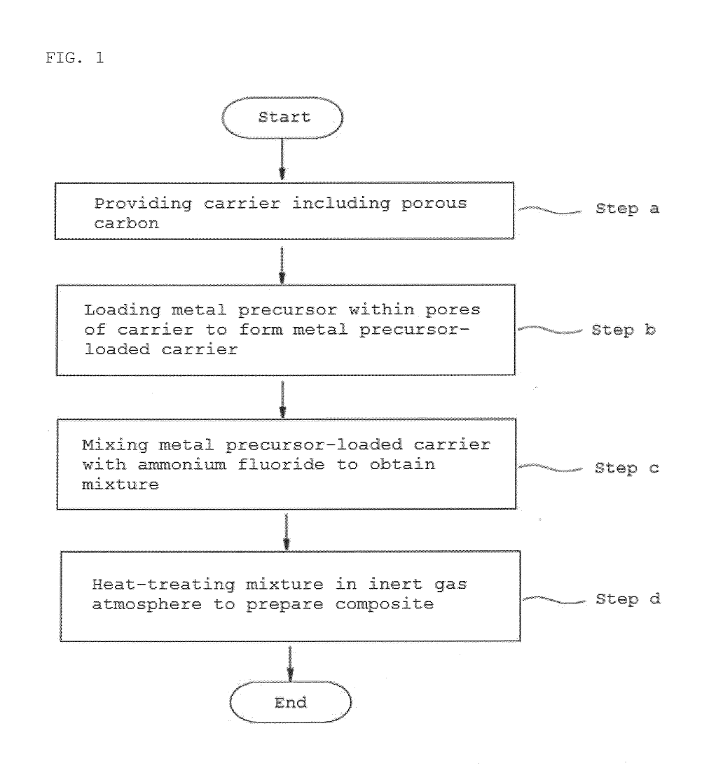

FIG. 1 is a flowchart sequentially illustrating the process of preparing the composite according to the present invention.

Below is a description of the method of preparing the composite according to the present invention with reference to FIG. 1.

Specifically, a carrier including porous carbon with a plurality of pores is provided (Step a).

The carrier may be formed using a hard template process, but the present invention is not limited thereto.

The hard template process refers to the synthesis of a mesoporous material using a previously made organic or inorganic template.

Thereafter, a metal precursor is provided, and is then loaded on the porous carbon, thus forming a metal precursor-loaded carrier (Step b).

Specifically, a wet impregnation process, including dissolving the metal precursor in a solvent to obtain a metal precursor solution and impregnating the carrier with the metal precursor solution, may be implemented, but the present invention is not limited thereto.

The solvent, which is contained in the metal precursor solution, may include, but is not limited to, ethanol, methanol, acetone, water, tetrahydrofuran, and chloroform, and any solvent may be used so long as it dissolves the metal precursor.

After the wet impregnation process, stirring and drying are performed, thereby evaporating the solvent.

The metal precursor may include at least one of copper, cobalt, iron, and nickel.

Preferably useful is a copper precursor containing copper, and the copper precursor may include, but is not limited to, Cu(NO₃)₂.xH₂O, CuCl₂.xH₂O, Cu(OH)₂.xH₂O, Cu(CH₃COO)₂.xH₂O (where x is 0 to 6), Cu₂(OH)₃NO₃, (NH₄)₂CuF₄, NH₄CuF₃, Cu(OH) F, CuO, and Cu₂O, and any material may be used so long as it reacts with ammonium fluoride to form copper ammonium fluoride.

After Step b, drying may be further performed at 50° C. or more, and preferably 50 to 100° C.

Subsequently, ammonium fluoride (NH₄F) is provided, and is then mixed with the metal precursor-loaded carrier, thus obtaining a mixture (Step c).

In the mixture, ammonium fluoride is preferably contained in an amount of at least two times, and more preferably two to ten times, the molar number of the metal contained in the metal precursor.

After Step c, grinding the mixture may be further performed.

The mixture is heat-treated in any one atmosphere selected from among an inert gas, nitrogen gas, and a vacuum, thereby forming a composite comprising a carrier including porous carbon with a plurality of pores and metal fluoride loaded on the porous carbon (Step d).

The inert gas may include helium (He), neon (Ne), argon (Ar), krypton (Kr), xenon (Xe), and radon (Rn). Argon is preferably used.

Here, the heat treatment may be performed at 150 to 300° C.

In addition, the present invention addresses a lithium ion battery comprising the composite as a cathode active material.

The lithium ion battery preferably includes a solid electrolyte.

The solid electrolyte may be exemplified by Li-ion-conducting glass ceramic, but the present invention is not limited thereto, and any solid electrolyte may be used, as long as only lithium ions can selectively pass therethrough.

### EXAMPLES

A better understanding of the present invention may be obtained through the following examples, which are set forth to illustrate, but are not to be construed to limit the present invention.

### Example 1

### Preparation of CuF₂/MSU-F-C Composite

### Preparation Example 1

### Formation of MSU-F-C

Mesoporous carbon (mesocellular carbon foam, MSU-F-C) was synthesized by a hard template process using mesocelluar aluminosilicate foam and furfuryl alcohol as a silica template and a carbon precursor, respectively.

### Preparation Example 2

### Preparation of CuF₂/MSU-F-C Composite

A copper precursor was loaded on MSU-F-C through a wet impregnation process. Specifically, a Cu(NO₃)₂.2.5H₂O ethanol solution was incorporated at room temperature, and to impregnate MSU-F-C with 55 wt % CuF₂ (e.g. 0.12 g of CuF₂+0.1 g of MSU-F-C), 0.1 g of MSU-F-C was impregnated with 0.28 g of a Cu(NO₃)₂.2.5H₂O ethanol solution.

Next, the ethanol solvent was evaporated with stirring, and was then further dried in a vacuum oven at 85° C., thus obtaining a copper precursor/MSU-F-C, which was then mechanically ground using a mortar and pestle together with NH₄F in an amount of 0.22 g, which corresponds to five times the molar number of copper contained in the copper precursor. The mixture thus obtained was heat-treated at 210° C. for 1 hr in an argon gas atmosphere, yielding a CuF₂/MSU-F-C composite. The composite thus prepared was placed in a glove box filled with argon.

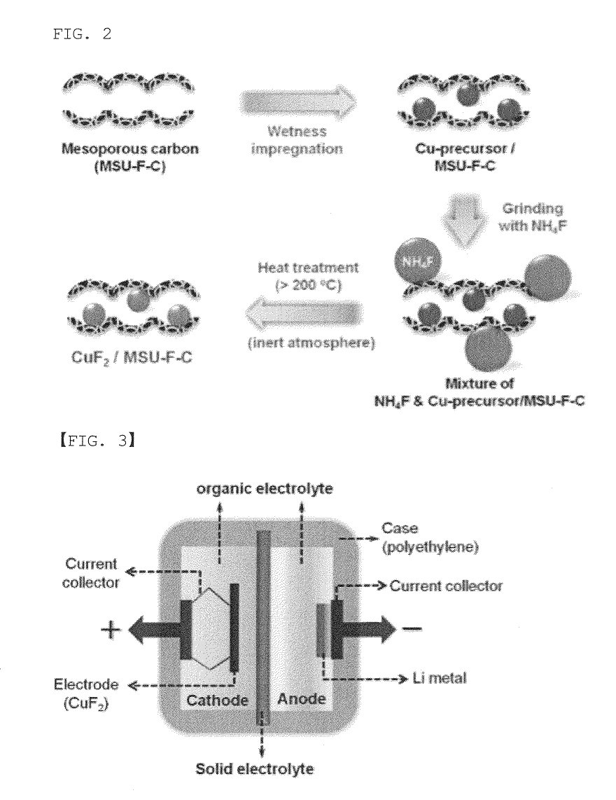

The preparation of the CuF₂/MSU-F-C composite in Example 1 is schematically illustrated in FIG. 2.

### Comparative Example 1

### Preparation of Bulky CuF₂

Bulky CuF₂ was prepared in the same manner as in Example 1, with the exception that MSU-F-C was not used.

### Comparative Example 2

### Preparation of Bulky CuF₂/MSU-F-C Mixture

A bulky CuF₂/MSU-F-C mixture was prepared by physically mixing the bulky CuF₂ of Comparative Example 1 with MSU-F-C.

### Comparative Example 3

### Preparation of MSU-F-C

MSU-F-C was prepared in the same manner as in Preparation Example 1.

### Comparative Example 4

### Preparation of Copper Precursor/MSU-F-C Composite

A copper precursor/MSU-F-C composite was prepared in the same manner as in Example 1, with the exception that grinding with NH₄F and heat treatment were not performed.

### Device Example 1

0.07 g of the CuF₂/MSU-F-C composite of Example 1, 0.02 g of PVDF (polyvinylidene fluoride), 0.01 g of Super P, and 0.9 mL of NMP (N-methyl-2-pyrrolidone) were mixed together and ground to make a paste, which was then applied on an aluminum foil and dried at room temperature for 48 hr in a vacuum, thus forming an electrode.

Subsequently, a portion of the electrode was removed in the form of a circular shape having a diameter of 14 mm, and was thus used as a cathode, and a circular lithium metal foil having a diameter of 8 mm was used as an anode, after which each electrode was fixed to a stainless steel current collector. Also, 1.5 mL of a solution (1M LiPF₆ in EC/DMC) of 1 mol LiPF₆ in a solvent mixture of ethylene carbonate and dimethyl carbonate at a volume ratio of 1:1 was used as a liquid electrolyte, and a solid electrolyte (LTAP) was additionally used, thereby manufacturing a lithium ion battery configured such that the cathode and the anode were physically blocked from each other. The fabrication of the electrode and the lithium ion battery was performed in a glove box filled with argon gas.

FIG. 3 schematically illustrates the lithium ion battery of Device Example 1.

### Device Comparative Example 1

A lithium ion battery was manufactured in the same manner as in Device Example 1, with the exception that the bulky CuF₂/MSU-F-C mixture of Comparative Example 2, rather than that of Example 1, was used as the cathode material.

### Device Comparative Example 2

A lithium ion battery was manufactured in the same manner as in Device Example 1, with the exception that the MSU-F-C of Comparative Example 3, rather than that of Example 1, was used as the cathode material.

### TEST EXAMPLES

### Test Example 1

### Analysis of XRD (X-Ray Diffraction) and TGA (Thermogravimetric Analysis)

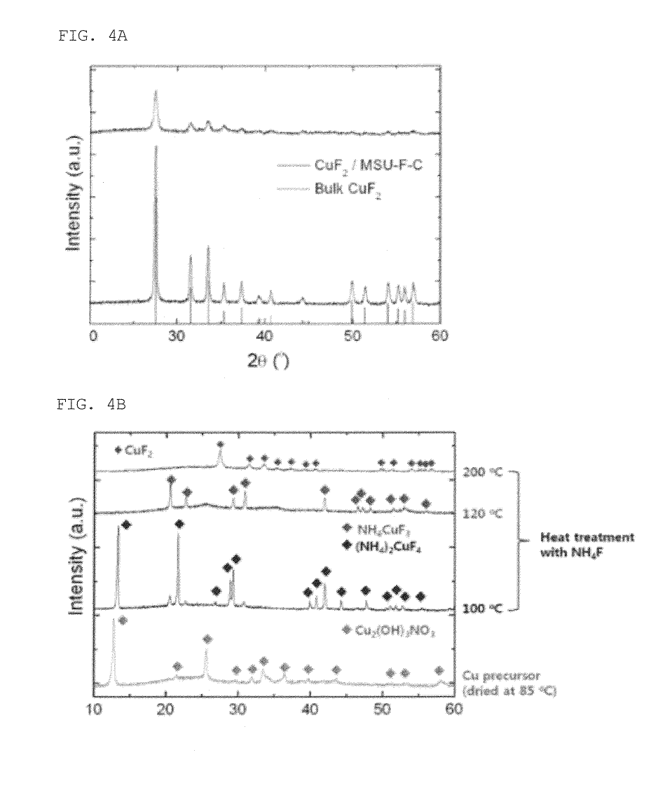

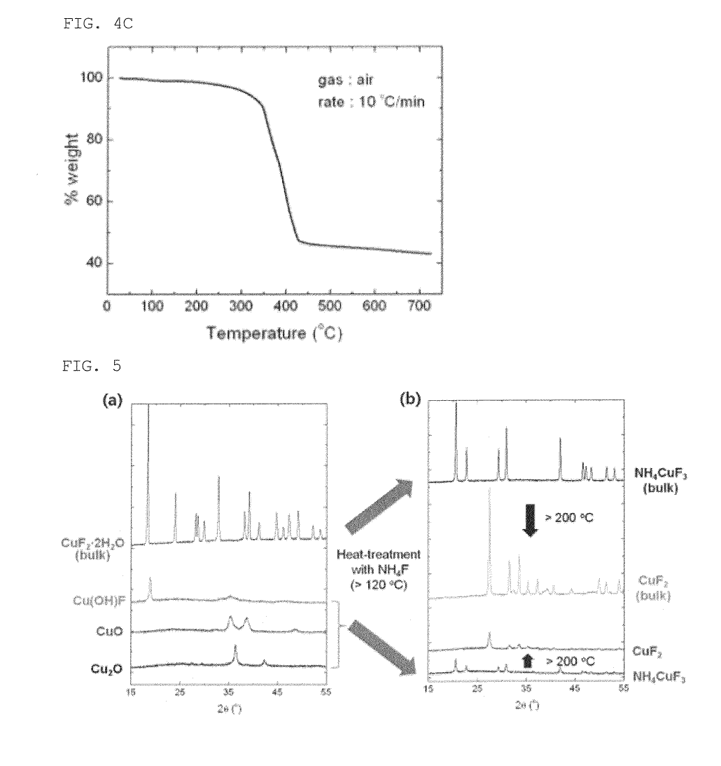

FIG. 4A illustrates the results of analysis of XRD of the CuF₂/MSU-F-C composite of Example 1 and the bulky CuF₂ of Comparative Example 1, FIG. 4B illustrates the results of analysis of XRD of changes in the crystal phase of the copper precursor/MSU-F-C composite during heat treatment with ammonium fluoride (NH₄F), and FIG. 4C illustrates the results of TGA.

As is apparent from the results of analysis of XRD of FIG. 4A, the CuF₂/MSU-F-C composite was manufactured. All the diffraction peaks corresponded to monoclinic CuF₂ (JCPDS No. 81-0486), and small and wide peaks appeared at about 25° due to the amorphous carbon carrier. Accordingly, it was confirmed that it was possible to efficiently convert the copper precursor of the copper precursor/MSU-F-C composite into CuF₂ during heat treatment with ammonium fluoride.

Based on the results of analysis of XRD of FIG. 4B, the copper precursor, which was first used, was converted into (NH₄)₂CuF₄ through the reaction with the decomposed product of ammonium fluoride at 100° C. (NH₄)₂CuF₄ was slowly decomposed into NH₄CuF₃ during the intermediate step, and anhydrous CuF₂ was finally formed through additional heat treatment at 200° C. or higher.

As illustrated in FIG. 4C, the amount of CuF₂ loaded in the CuF₂/MSU-F-C composite of Example 1 was measured through TGA in air. The mass loss rate, observed in the TGA graph, was almost the same as the sum of the amount of 45 wt % MSU-F-C and the mass loss of 12% or less due to the oxidation (CuF₂→CuO) of CuF₂. Thus, the amount of CuF₂ in the composite was measured to be about 55 wt %, which is evaluated to be almost equal to the desired value. Furthermore, the reaction of the invention is solventless, and is thus an efficient process that prevents the loss of product due to the partial dissolution of the fluoride compound in the reaction solution.

### Test Example 2

### Synthesis of CuF₂ from Various Copper Precursors

The conversion of various copper precursors into CuF₂ through heat treatment was measured through XRD. The results are illustrated in FIG. 5.

As illustrated in FIG. 5, a variety of copper compounds were finally converted into CuF₂ through heat treatment with NH₄F. Such copper compounds may thus be used as the copper precursor of the invention. Also, CuF₂ synthesis is very simple and obviates the need for hazardous hydrofluoric acid aqueous solution or toxic gases, which require specific handling equipment, and is thus very efficient.

### Test Example 3

### Analysis of SEM and TEM Images and of Nitrogen Physisorption Isotherms

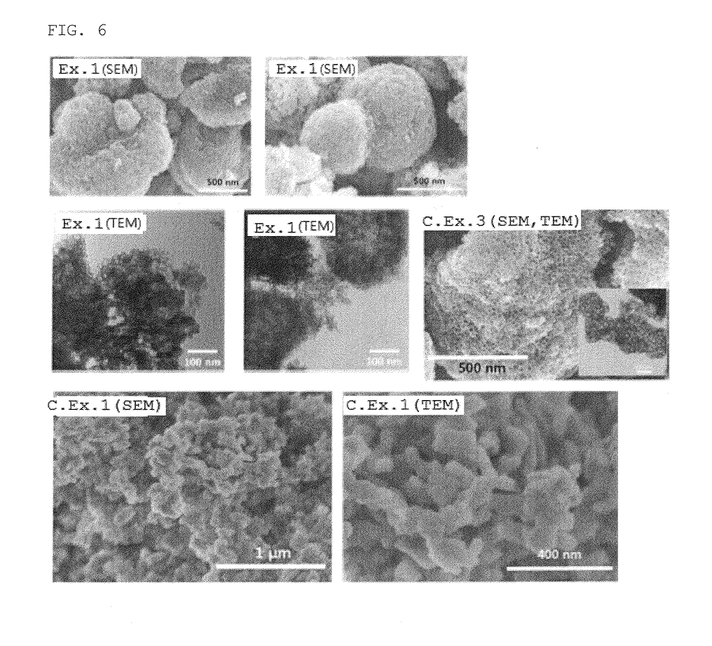

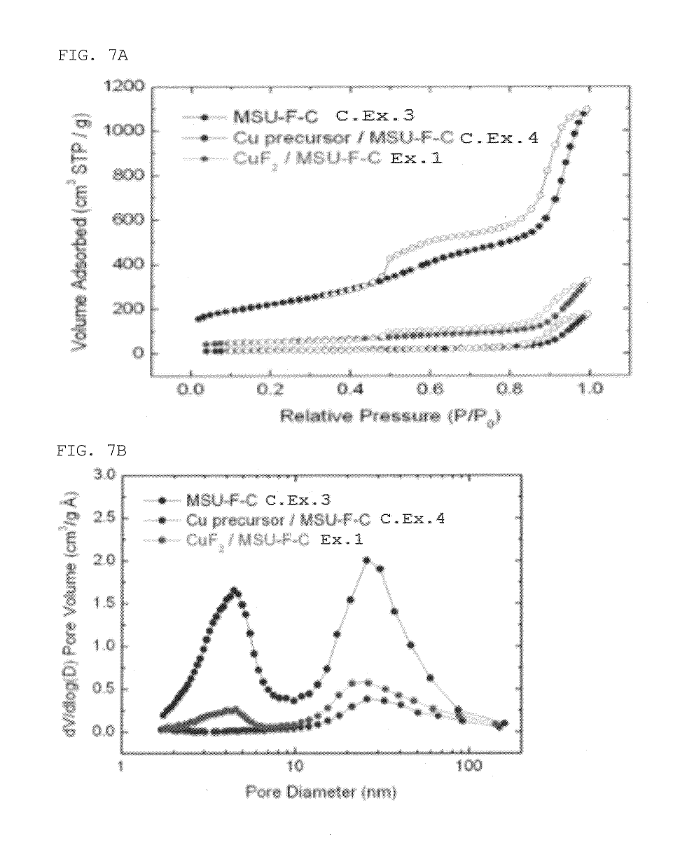

The SEM and TEM images of the CuF₂/MSU-F-C composite of Example 1, bulky CuF₂ of Comparative Example 1 and MSU-F-C of Comparative Example 3 are illustrated in FIG. 6. Also, FIGS. 7A and 7B illustrate the results of analysis of nitrogen physisorption isotherms and pore distributions of the products of Example 1 and Comparative Examples 3 and 4 (copper precursor/MSU-F-C composite).

The nano-sized active material is loaded on porous carbon to thus realize high dispersibility, and can provide the electron conduction path. Thus, mesoporous carbon, namely MSU-F-C, may be used as the carrier of CuF₂.

As illustrated in FIGS. 6 and 7A and 7B, MSU-F-C had uniform mesopores having a diameter of 30 nm or less. Based on the results of analysis of nitrogen physisorption isotherms, there was found to exist two kinds of pores, one having a diameter of 5 nm or less (produced by etching of the wall of the template) and the other having a diameter of 30 nm or less (derived from main pores of the template), with large surface area (˜800 m²/g) and pore volume (1.7 cm³/g). Thanks to such pore structures and surface properties, nanoparticles having a size of 10 nm or less were loaded within the pores without agglomeration, and an interconnected electron conduction path in a wide range was provided.

As seen in the SEM images of the CuF₂/MSU-F-C composite (Example 1), the image of the bulky CuF₂ (Comparative Example 1) was not observed, and the overall shape of MSU-F-C was not significantly changed when compared with the image of Comparative Example 3. These results showed that the CuF₂ nanoparticles were mostly loaded within the pores of MSU-F-C, and only some of the particles were significantly grown and protruded from the pores.

As seen in the TEM images, the particles were positioned near or on the pores of MSU-F-C, and the size of the particles was similar to the size of the pores.

Based on the results of nitrogen physisorption, loading of CuF₂ on MSU-F-C was additionally proven. Specifically, the surface area of CuF₂/MSU-F-C and the pore volume thereof were decreased by 25% compared to MSU-F-C, from which it was inferred that the CuF₂ particles were distributed within the pores and had an influence on the surface properties of MSU-F-C, taking into consideration the loading of 55% CuF₂. Furthermore, the CuF₂ particles were neither isolated from the pores nor externally grown.

The pore size distribution indicates easy penetration of the copper precursor and the growth of CuF₂ in the pores of MSU-F-C. Since small pores are preferentially filled with the precursor solution due to strong capillary action, the volume of small pores may be significantly decreased compared to that of large pores. This expectation is consistent with the results based on the curved line of the copper precursor/MSU-F-C, which has a single peak of 30 nm or less. After heat treatment with NH₄F, the decomposition of the precursor and the growth of the particles occurred together, whereby the small pores were exposed again. Also, the curved line having two peaks, the intensities of which were decreased, was observed in CuF₂/MSU-F-C.

### Test Example 4

### Analysis of Electrochemical Properties (Initial Charge/Discharge Profile)

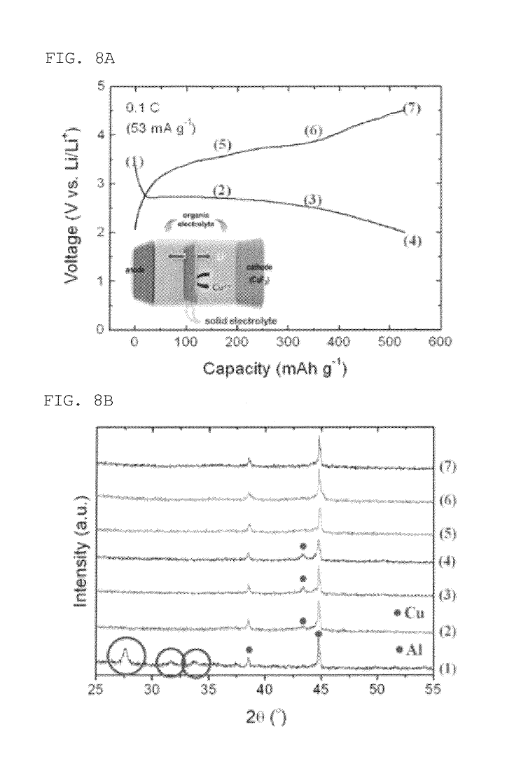

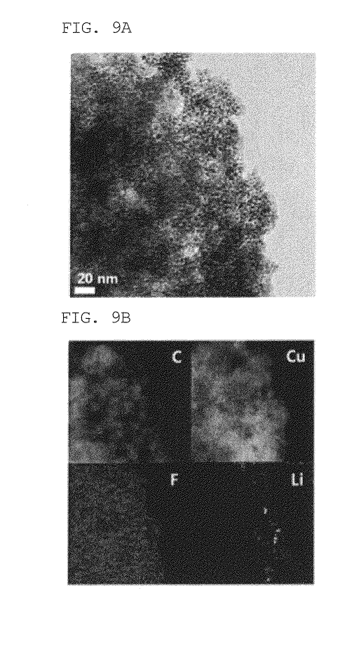

FIG. 8A illustrates the initial charge/discharge profile of the lithium ion battery of Device Example 1 at a discharge rate of 0.1 C, and FIG. 8B illustrates the results of analysis of the XRD pattern of the CuF₂/MSU-F-C electrode during the electrochemical reaction.

As illustrated in FIG. 8A, the charging voltage profile was increased from 2.0 V to 4.5 V. After the first cycle, the deposition of Cu on Li metal and the drastic surface changes were not observed. The Cu ions were not detected in the electrolyte near the anode. In the electrolyte near the cathode, the separation of Cu ions began during the charging, but only 10% or less of the Cu contained in the cathode material was detected after the completion of charging.

As illustrated in FIG. 8B, the numerals of the drawings correspond to the charging or discharging step of FIG. 8A. The disappearance of the peak means that the crystal size is decreased, and also that the phase is converted to be amorphous. Since the crystal size of the CuF₂ particles in MSU-F-C is reduced, it may be rapidly decreased below the detection threshold, which appears similarly in the discharging step. As the discharging continued, small peaks matching Cu metal were observed, which proves that the conversion reaction from Curve 2 to Curve 4 occurs. However, the peaks corresponding to LiF were not clearly shown. This is considered to be because the LiF formed through the conversion reaction has smaller crystals than those of Cu.

In the final charging (Curve 7), peaks matching CuF₂ were not observed again. This is deemed to be because CuF₂, converted again from the discharge material, has smaller crystals or is in an amorphous phase.

### Test Example 5

### Analysis of Electrochemical Properties (TEM of Electrode after Charging/Discharging, Elemental Mapping)

FIG. 9A illustrates the TEM image after charging of the CuF₂/MSU-F-C electrode used in Device Example 1, and FIG. 9B illustrates the results of elemental mapping thereof.

As seen in FIGS. 9A and 9B, the TEM images showed that the particle size of CuF₂ was reduced to 4 nm or less through the charging and discharging, and the elemental mapping results showed that the small particles were composed mainly of Cu and F. This is because Li escapes and CuF₂ is formed again during the charging.

### Test Example 6

### Analysis of Electrochemical Properties (Cycling Characteristics)

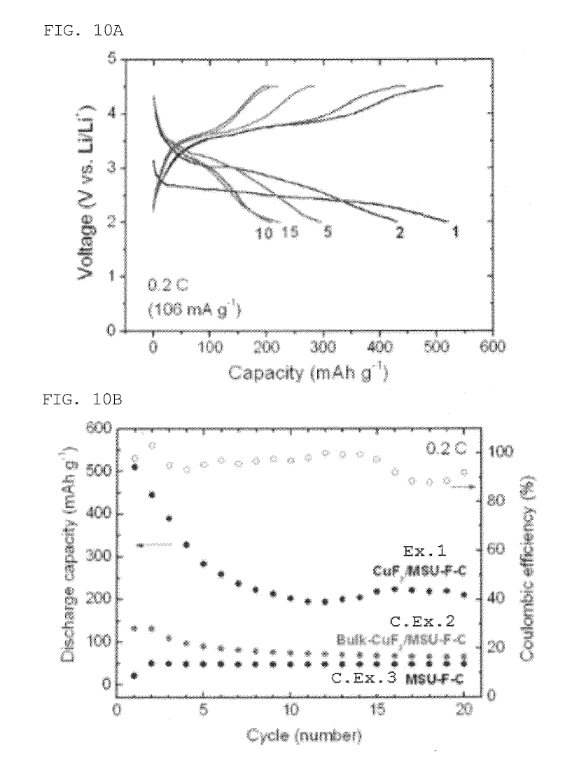

FIG. 10A illustrates the voltage profile of CuF₂/MSU-F-C in the lithium ion battery of Device Example 1 under conditions of 15 cycles and a 0.2 C discharge rate, and FIG. 10B illustrates the cycling characteristics upon 20 cycles of the electrode material in the lithium ion batteries of Device Example 1 and Device Comparative Examples 1 and 2. As seen in FIG. 10B, the violet hollow circular mark indicates the coulombic efficiency of the CuF₂/MSU-F-C composite.

As shown in FIG. 10A, the shape and position of the profile were altered during the cycling, depending on phase changes in CuF₂. Decreasing the crystal size or forming the amorphous phase increased the discharge voltage, and the profile shape was changed to be inclined at the top. This is observed generally in typical conversion reactions of metal compounds and Li.

As shown in FIG. 10B, in the initial stage of cycling, the capacity was decreased relatively quickly. Some of the active material particles were significantly grown, or the dissolution of Cu was rapidly caused at the protrusions thereof. Due to the overvoltage of the material based on the conversion reaction, the discharge material was not partially converted, thus decreasing the capacity at the initial cycle. However, in the subsequent cycling, a stable discharge capacity of 150 mAh g⁻¹ in CuF₂ was observed. Compared to Device Comparative Example 1, the lithium ion battery of Device Example 1 exhibited superior electrode cycling characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1: A composite, comprising:
a carrier including porous carbon with a plurality of pores; and
metal fluoride loaded on the porous carbon.

2: The composite of claim 1, wherein the metal fluoride is loaded on an inner wall of the carbon in the pores.

3: The composite of claim 1, wherein the metal fluoride comprises at least one selected from among copper fluoride (CuF₂), cobalt fluoride (CoF₂), iron fluoride (FeF₂, FeF₃), and nickel fluoride (NiF₂).

4: The composite of claim 1, wherein the pores have a diameter of 1 to 100 nm.

5: The composite of claim 1, wherein the metal fluoride is used in an amount of 30 to 90 wt % based on a total weight of the composite.

6: A method of preparing a composite, comprising:
(a) providing a carrier including porous carbon with a plurality of pores;
(b) loading a metal precursor on the porous carbon, thus forming a metal precursor-loaded carrier;
(c) mixing the metal precursor-loaded carrier with ammonium fluoride (NH₄F), thus obtaining a mixture; and
(d) heat-treating the mixture in any one atmosphere selected from among an inert gas, nitrogen gas, and a vacuum, yielding a composite comprising a carrier including porous carbon with a plurality of pores and metal fluoride loaded on the porous carbon.

7: The method of claim 6, wherein the metal fluoride is loaded on an inner wall of the carbon in the pores.

8: The method of claim 6, wherein the metal precursor comprises at least one selected from among copper, cobalt, iron, and nickel.

9: The method of claim 6, wherein the metal precursor comprises at least one selected from among Cu(NO₃)₂.xH₂O, CuCl₂.xH₂O, Cu(OH)₂.xH₂O, Cu(CH₃COO)₂.xH₂O, Cu₂(OH)₃NO₃, (NH₄)₂CuF₄, NH₄CuF₃, Cu(OH)F, CuO, and Cu₂O, where x is 0 to 6.

10: The method of claim 6, wherein (b) is performed using a wet impregnation process, comprising dissolving the metal precursor in a solvent to obtain a metal precursor solution and impregnating the carrier with the metal precursor solution.

11: The method of claim 10, wherein the solvent comprises at least one selected from among ethanol, methanol, acetone, water, tetrahydrofuran, and chloroform.

12: The method of claim 10, wherein stirring and drying are performed after the wet impregnation process.

13: The method of claim 12, further comprising performing drying at 50 to 100° C., after (b).

14: The method of claim 6, wherein the ammonium fluoride in the mixture in (c) is contained in an amount of two to ten times a molar number of a metal contained in the metal precursor.

15: The method of claim 6, further comprising grinding the mixture, after (c).

16: The method of claim 6, wherein the inert gas is argon.

17: The method of claim 6, wherein the heat-treating in (d) is performed at 150 to 300° C.

18: A lithium ion battery, comprising the composite of claim 1 as a cathode active material.

19: The lithium ion battery of claim 18, wherein the lithium ion battery comprises a solid electrolyte.
